(19) United States
(12) Patent Application Publication
(10) Pub. No.: US 2025/0370633 A1
(43) Pub. Date: Dec. 4, 2025

(54) ENHANCED PARITY FORMATION FOR FAULT TOLERANCE IN MEMORY DEVICES

(71) Applicant: Micron Technology, Inc., Boise, ID (US)

(72) Inventor: Lei Zhang, Singapore (SG)

(21) Appl. No.: 19/198,536

(22) Filed: May 5, 2025

Related U.S. Application Data
(60) Provisional application No. 63/654,195, filed on May 31, 2024.

(51) Int. Cl. G06F 3/06

(52) U.S. Cl. CPC G06F 3/0619; G06F 3/065; G06F 3/0679

(57) ABSTRACT

A parity group identifier is calculated for each page of a plurality of pages of a block of a memory device storing host data based on a page number of a respective page and a wordline number derived from the page number. The page number is appended to an array of page numbers assigned to a parity group identified by the parity group identifier. Redundancy metadata is calculated for each parity group of a plurality of parity groups based on the array of page numbers assigned to a respective parity group. The redundancy metadata is stored in a page of the block identified by a last page number of the array of page numbers assigned to the respective parity group.

### RELATED APPLICATIONS

This application claims the benefit of U.S. Provisional Patent Application No. 63/654,195, filed May 31, 2024, which is incorporated in its entirety by reference herein.

### TECHNICAL FIELD

Embodiments of the disclosure relate generally to memory sub-systems, and more specifically, relate to enhanced parity formation for fault tolerance in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram illustrating a block of memory in accordance with some embodiments of the present disclosure.

FIG. 3 is a block diagram illustrating assignment of a plurality of pages of the block to a plurality of parity groups in accordance with some embodiments of the present disclosure.

FIG. 4 is a flow diagram of an example method to enhance parity formation for 2WL RAIN protection in accordance with some embodiments of the present disclosure.

FIG. 5 is a block diagram of an example computer system in which embodiments of the present disclosure may operate.

### DETAILED DESCRIPTION

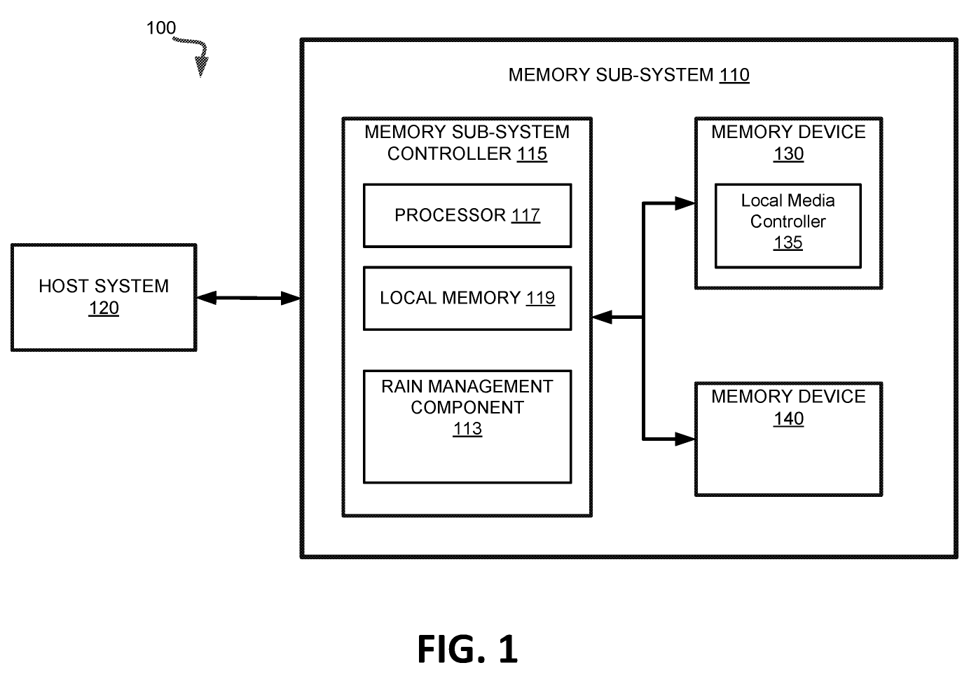

Aspects of the present disclosure are directed to enhanced parity formation for fault tolerance in memory devices. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non- volatile memory devices is a not-and (NAND) memory device. Other examples of non-volatile memory devices are described below in conjunction with FIG. 1. A non-volatile memory device is a package of one or more dies. Each die can includes of one or more planes. For some types of non-volatile memory devices (e.g., NAND devices), each plane includes of a set of physical blocks. Each block includes of a set of pages. Each page includes of a set of memory cells ("cells"). A cell is an electronic circuit that stores information. Depending on the cell type, a cell can store one or more bits of binary information, and has various logic states that correlate to the number of bits being stored. The logic states can be represented by binary values, such as "0" and "1", or combinations of such values.

A memory device can include multiple memory cells arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. Each block can also be split into one or more sub-blocks along a given wordline. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A memory sub-system can support a redundancy mechanism to protect host data against memory access failures. For example, for a NAND type flash device, the memory sub- system can implement redundant array of independent NAND (RAIN) units to provide redundancy for the data stored on the memory sub-system. When host data (e.g., one or more codewords) is received from the host system to be programmed to a memory device of the memory sub-system, a memory sub-system controller can generate redundancy metadata, e.g.,by performing one or more exclusive disjunction (XOR) operations on the received host data, and can use the redundancy metadata to reconstruct the host data in the event of a failure of a portion of the memory device that is storing host data. As an example, the memory sub-system controller can generate one or more RAIN standard codewords (redundancy metadata) based on an XOR operation applied to host data stored at a particular number of data locations of one or more logical units (LUNs) (e.g., a page, a block) of the memory sub-system. If a portion of a memory device storing the host data fails and the corresponding data is lost or corrupted, the memory sub-system controller can reconstruct the lost/corrupted data based on an XOR operation among the rest of the host data and the redundancy metadata.

Depending on the reliability requirements of the memory sub-system, the memory sub- system may adjust the level (or degree) of protection for the RAIN. The varying level of protection for RAIN, from highest to lowest, typically includes die RAIN, block RAIN, and two wordline (2WL) RAIN.

Die RAIN operates at the individual NAND flash memory die level, providing redundancy within each die. Redundancy in die RAIN is achieved by distributing both data and parity information across multiple dies within a single NAND type flash device. This level of redundancy offers the highest level of protection against die-level failures, such as defects or failures in individual NAND dies. However, die RAIN typically comes with the highest storage overhead because it requires redundant storage of both data and parity information within each die.

Block RAIN operates at a higher level, providing redundancy at the level of NAND flash memory blocks. In block RAIN, redundancy is achieved by distributing data and parity information across multiple blocks within a NAND flash device. This level of redundancy offers protection against block-level failures, such as bad blocks or failures in entire NAND flash memory blocks. Block RAIN typically incurs lower storage overhead compared to die RAIN, as redundancy is achieved at a higher level of granularity (blocks rather than individual dies).

2WL RAIN is a variation of RAIN that utilizes redundancy at the wordline level within NAND flash memory cells. In 2WL RAIN, redundancy is achieved by utilizing two wordlines per memory cell instead of one wordline, providing enhanced fault tolerance and error correction capabilities. More specifically, 2WL RAIN utilizes a subset of non-consecutive pages in a block for parity formation to formulate a single parity. This level of redundancy offers protection against wordline-level failures and errors, providing additional reliability in NAND flash memory systems. 2WL RAIN typically incurs lower storage overhead compared to both die RAIN and block RAIN, making it a more efficient option in terms of storage utilization. While the protection provided by 2WL RAIN is limited to defects that span 2 wordlines or less, 2WL RAIN is further susceptible to pillar-related failures. Pillar-related failures refers to defects associated with conducting pillars connecting wordlines to memory cells. Accordingly, there is a need to increase the number of wordlines that can experience a defect as well as prevent pillar-related failures in 2WL RAIN protection without reducing its efficiency in terms of storage utilization.

Aspects of the present disclosure address the above and other deficiencies by systematically organizing pages from a block into separate RAIN parity groups for enhancing parity formation for 2WL RAIN protection. In some embodiments, the memory sub-system controller identifies a block of a memory device storing host data. The memory sub-system controller determines a block type of the block based on the number of bits stored per cell. In some embodiments, the block type may be a single level cell (SLC) block (e.g., a single bit per cell), a multi-level cell (MLC) block (e.g., multiple bits per cell), a triple level cell (TLC) block (e.g., three bits per cell), a quad-level cell (QLC) block (e.g., four bits per cell), or a penta-level cell (PLC) block (e.g., five bits per cell).

The memory sub-system determines, based the block type, an equation to calculate a parity group identifier. The memory sub-system, for each page of the block, calculates a parity group identifier using the equation. For example, the memory sub-system may utilize, as input into the equation, a page number of a given page and/or a wordline number calculated from the page number of the given page. Each block contains multiple pages, and these pages are arranged sequentially within the block. Each page is identified by a page number which effectively represents the position of the page within the block. The wordline corresponding to a page number within the block can be calculated using basic division. For example, since each block contains a fixed number of pages and wordlines, dividing the page number by the number of pages per wordline (typically referred to as the page size) yields the wordline number. The output of the equation (e.g., the parity group identifier) provides a numerical value indicating which parity group the given page belongs. The memory sub-system appends a page number of the given page to an array (e.g., array of page numbers) assigned to a parity group identified by the parity group identifier.

In some embodiments, the memory sub-system may determine, based the block type, a set of equations, rather than a single equation, to calculate the parity group identifier. A first equation of the set of equations is used to calculate the parity group identifier for a first subset of the pages of the block, and a second equation of the set of equations is used to calculate the parity group identifier for a second subset of the pages of the block. In some embodiments, the first equation may utilize a wordline number calculated from a page number of a given page, and the second equation may utilize a page number of a given page and a wordline number calculated from the page number.

Once the page numbers of all pages of the block are appended to an array assigned to a parity group, the memory sub-system performs an exclusive-OR (XOR) operation for each parity group to obtain redundancy metadata (parity information or parity metadata). More specifically, the memory sub-system identifies, for a given parity group, the array assigned to the given parity group and performs the XOR operation on the host data stored in each page identified (by page number) in the array of the given parity group. The memory sub-system stores the redundancy metadata in a page identified by a last page number appended to the array for the given parity group. The memory sub-system performs a programming operations with the redundancy metadata on the page identified using the last page number in the array.

In some embodiments, in response to a defective page of the block, the memory sub- system reconstructs the defective page of the block by identifying a page storing the redundancy metadata. More specifically, the memory sub-system determines the block type of the block with the defective page based on the number of bits stored per cell. The memory sub-system determines, based the block type, an equation (or set of equations) to calculate a parity group identifier for the block. For each page of the block, the memory sub-system calculates a parity group identifier using the equation (or set of equations). The memory sub-system appends a page number of the given page to an array (e.g., array of page numbers) assigned to a parity group identified by the parity group identifier. Once the page numbers of all pages of the block are appended to an array assigned to a parity group, for each parity group of the plurality of parity groups, the memory sub-system determines whether a page number of an array of a given parity group includes a page number of the defective page. The memory sub-system, based on a match, identifies a last page number in the array of the given parity group that includes the page number of the defective page. The memory sub-system performs a read operations on a page identified by the last page number in the array of the given parity group that includes the page number of the defective page. The memory sub-system, using the read redundancy metadata, reconstructs the defective page.

Advantages of the present disclosure include, but are not limited to, providing protection against pillar-related defects, and increasing the level or protection for the 2WL RAIN while maintaining the storage efficiency of the 2WL RAIN.

FIG. 1 illustrates an example computing system 100 that includes a memory sub- system 110 in accordance with some embodiments of the present disclosure. The memory sub- system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi- Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in- line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, "coupled to" or "coupled with" generally refers to a connection between components, which can be an indirect communicative connection. or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point ("3D cross-point") memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non- volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)- MRAM, conductive bridging RAM (CBRAM), resistive random access memory (RRAM), oxide based RRAM (OxRAM), not-or (NOR) flash memory, or electrically erasable programmable read- only memory (EEPROM).

A memory sub-system controller 115 (or controller 115 for simplicity) can communicate with the memory devices 130 to perform operations such as reading data, writing data, or erasing data at the memory devices 130 and other such operations. The memory sub- system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub- system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub- system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub- system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a redundant array of independent NAND (RAIN) management component 113 that can enhance parity formation for 2WL RAIN protection by systematically organizing pages from a block into separate RAIN parity groups used for parity formation. In some embodiments, the memory sub-system controller 115 includes at least aportion of the RAIN management component 113. In some embodiments, the RAIN management component 113 is part of the host system 120, an application, or an operating system. In other embodiments, local media controller 135 includes at least a portion of RAIN management component 113 and is configured to perform the functionality described herein.

The RAIN management component 113 identifies a block of memory device 130 and/or 140 storing host data. The block includes a plurality of pages. The RAIN management component 113 determines a block type (of the block). The block type may be an SLC, MLC, TLC, QLC, or PLC block. Based on the block type, the RAIN management component 113 selects an equation or set of equations to calculate a parity group identifier for each page of the plurality of pages. The set of equations may include a first equation for a first subset of the plurality of pages, and a second equation for a second subset of the plurality of pages. Prior to calculating the parity group identifier, the RAIN management component 113, for each page of the plurality of pages may calculate a wordline number corresponding to a page number of a respective page within the block.

In some embodiments, if the RAIN management component 113 selected a set of equations, the RAIN management component 113 determines, based on a page number for a respective page, which equation of the set of equations to use. For example, for an SLC block, a first equation of the set of equations (e.g., (WL number + 3) modulo 8) is used if page number modulo 8 is equal to 7, otherwise a second equation of the set of equations (e.g., (page number + WL number) modulo 8) is used. For TLC block, a first equation of the set of equations (e.g., (WL number + 21) modulo 24) is used if page number modulo 24 is equal to 23, otherwise a second equation of the set of equations (e.g., (page number + WL number) modulo 24) is used. In this example, the RAIN management component 113 utilizes the calculated wordline number corresponding to the page number for the respective page in the first equation, or the page number for the respective page and the calculated wordline number corresponding to the page number for the respective page in the second equation.

After calculating the parity group identifier for a respective page, the RAIN management component 113 appends the page number of a respective page to an array (e.g., an array of page numbers) assigned to a parity group identified by the parity group identifier for the respective page. The RAIN management component 113 performs, for each array assigned to a parity group, an exclusive-OR (XOR) operation on the host data stored in each page identified by the array of a respective parity group to generate redundancy metadata for the respective parity group. In particular, the RAIN management component 113 iterates through each page number of the array, using a respective page of the array obtains host data stored in a page identified by the respective page number. The RAIN management component 113 performs the XOR operation on the obtained host data. The RAIN management component 113 stores the redundancy metadata for the respective parity group in a page identified by a last page number of the array assigned to the respective parity group. The last page number of the array refers to a page number that was appended last to the array. Thus, RAIN management component 113 performs a programming operation with the redundancy metadata for the respective parity group on a page of the block associated with the last page number of the array of the respective parity group.

The RAIN management component 113, in response a page of the block experiencing a defect or failure (e.g., a defective page), reconstructs the defective page of the block by identifying a page of the block storing the redundancy metadata associated with the defective page. The RAIN management component 113 determines the block type of the block. The RAIN management component 113 determines, based the block type, an equation (or set of equations) to calculate a parity group identifier. The RAIN management component 113, for each page of the block, calculates a parity group identifier using the equation (or set of equations). After calculating the parity group identifier for a respective page, the RAIN management component 113 appends the page number of a respective page to an array (e.g., array of page numbers) assigned to a parity group identified by the parity group identifier for the respective page.

Once the page numbers of all pages of the block are appended to an array assigned to a parity group, for each parity group of the plurality of parity groups, the RAIN management component 113 determines whether a page number of an array of a respective parity group includes a page number of the defective page. The RAIN management component 113, based on a match, identifies a last page number in the array of the respective parity group that includes the page number of the defective page. The RAIN management component 113 performs a read operations on a page identified by the last page number in the array of the respective parity group that includes the page number of the defective page. The RAIN management component 113, using the redundancy metadata, reconstructs the defective page. Further details with regards to the operations of the RAIN management component 113 are described below.

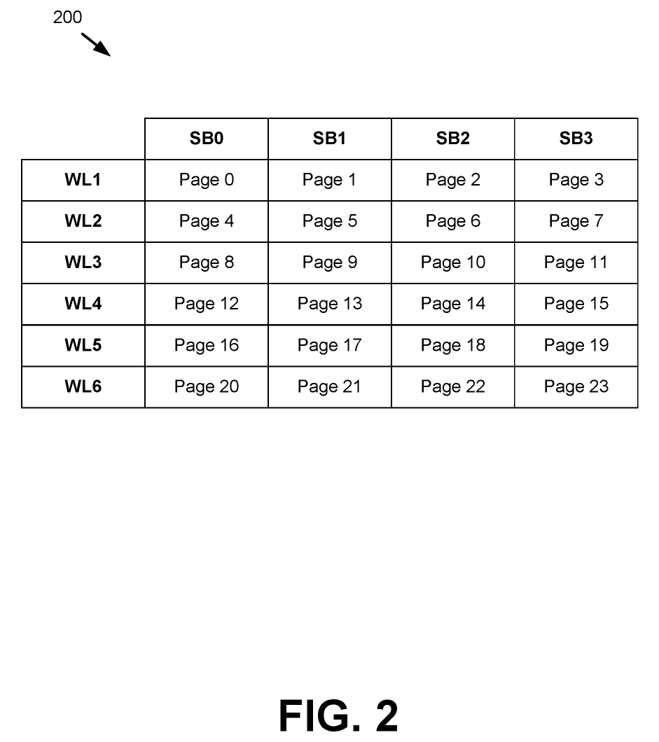

FIG. 2 is a block diagram illustrating an example block of a memory device, in accordance with some embodiments of the present disclosure. As illustrated in FIG. 2, a memory device (e.g., the memory device 130 of FIG. 1) can include a die. The die can have a set of wordlines that are formed across planes of the die. For example, the die can have a set of wordlines starting with WLO (i.e., a wordline with an index value of 0) to WL6 (i.e., a wordline with an index value of 6). The die can be sub-divided into one or more sub-blocks. For example, the die can have a set of sub-blocks such as SB0, SB1, SB2, SB3. Block 200 illustrates the set of wordlines (e.g., WLO-WL6) divided into a set of sub-blocks (SB0-SB3). A plurality of pages (e.g., pages 0-23) are sequentially distributed within block 200. In particular, a subset of the pages of the plurality of pages (e.g., a predefined number of pages matching the number of sub-blocks in a wordline) are distributed sequentially to a wordline before proceeding to a subsequent wordline of the set of wordlines. For example, a first page is stored at the beginning of WLO (e.g., at SB0), then a second page is stored at subsequent portion of WLO (e.g., at SB 1), then a third page is stored at subsequent portion of WLO (e.g., at SB2), then a fourth page is stored at subsequent portion of WLO (e.g., at SB3), the proceeds to WL1 to repeat until the end of WL 6 is reached.

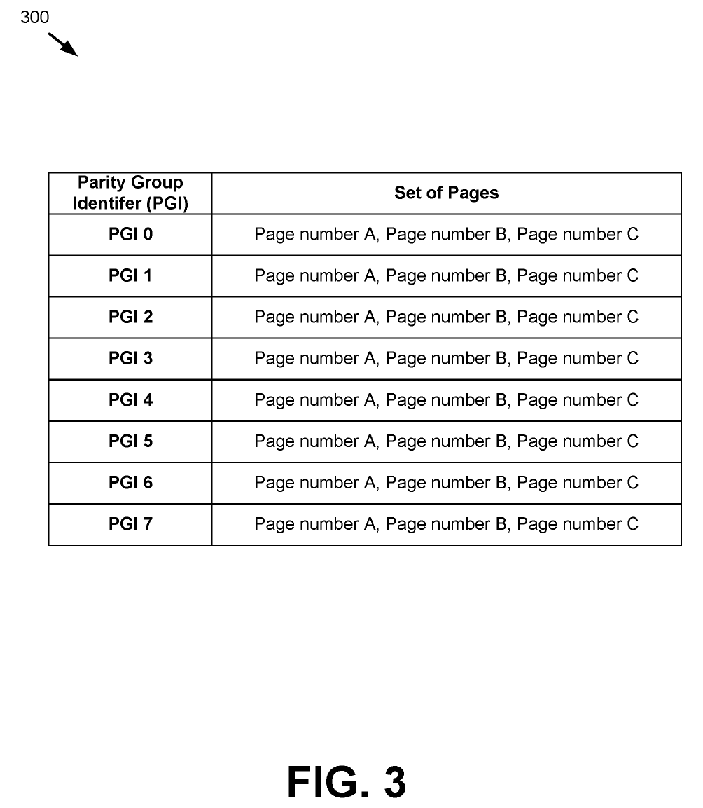

FIG. 3 is a block diagram illustrating assignment of a plurality of pages of the block to a plurality of parity groups, in accordance with some embodiments of the present disclosure. As illustrated in FIG. 3, a parity formation table 300 includes a plurality of rows. Each row corresponds to a parity group used for formation and is identified by a parity group identifier (PGI) (e.g., PGI 0-7). Each row includes a set of pages. The set of pages is represented by an array of page numbers (e.g., page number A, page number B, page number C) that corresponds to pages that are assigned to a parity group. As previously described, a RAIN management component (e.g., the RAIN management component 113 of FIG. 1) identifies a block of a memory device storing host data. The RAIN management component determines a block type of the block to determine an equation (or set of equations) to calculate a parity group identifier for each page of a plurality of pages of the block. The RAIN management component, for each page of the block, calculates a parity group identifier using the equation (or set of equations). The RAIN management component appends each page number to an entry of a row identified by the calculated parity group identifier.

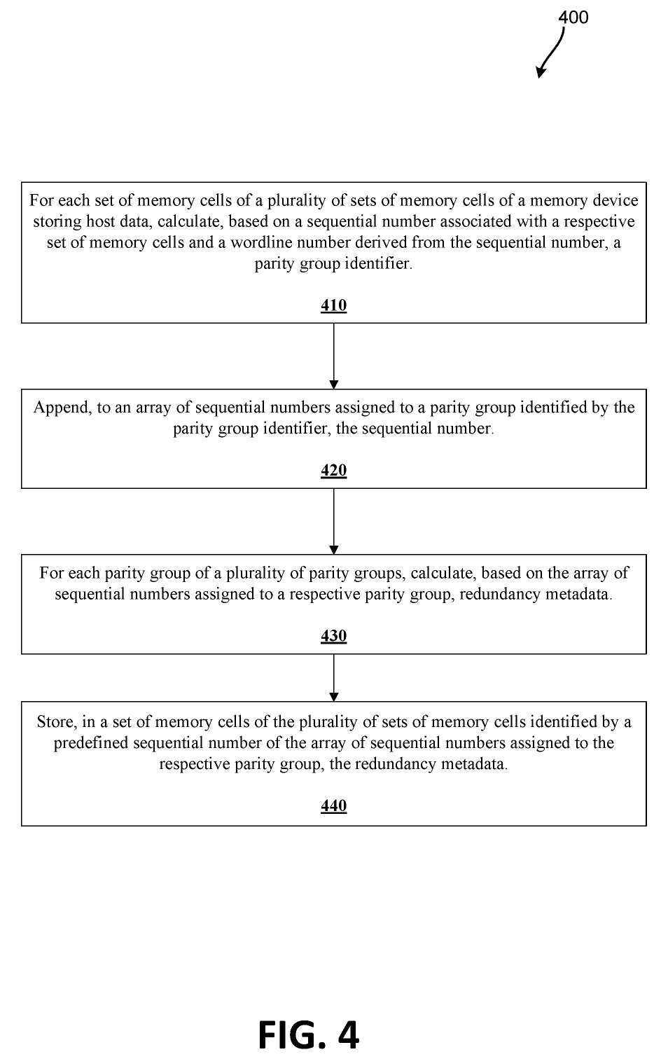

FIG. 4 is a flow diagram of an example method 400 to enhance parity formation for 2WL RAIN protection, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the RAIN management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, for each set of memory cells (e.g., page) of a plurality of sets of memory cells (e.g., a plurality of pages of a block) of a memory device storing host data, the processing logic calculates a parity group identifier based on a sequential number (e.g., a page number) associated with a respective set of memory cells and a wordline number derived from the sequential number . As previously described, since each block contains a fixed number of pages and wordlines, dividing the page number by the number of pages per wordline yields the wordline number.

To calculate the parity group identifier, the processing logic determines a block type of the block then identifies a mathematical transformation (e.g., an equation or set of equations) associated with the block type based on the block type. As previously described, the block type may be an SLC block, an MLC block, a TLC block, a QLC block, or a PLC block. As previously described, the set of equations may include a first equation and a second equation. The first equation may utilize the wordline number in its calculation, and the second equation may utilize the page number and the wordline number in its calculation. The processing logic inputs the page number (of the respective page) and the wordline number (derived from the page number) into the equation (or one equation of the set of equation) to calculate the parity group identifier.

At operation 420, the processing logic appends the sequential number to an array of sequential numbers assigned to a parity group identified by the parity group identifier. As previously described, after each calculation of the parity group identifier for a respective page number, the page number is appended to an array (e.g., array of page numbers) assigned to a parity group identified by the parity group identifier. Accordingly, all page numbers corresponding to the plurality of pages are appended to a parity group of a plurality of parity groups based on their calculated parity group identifier.

At operation 430, for each parity group of a plurality of parity groups, the processing logic calculates redundancy metadata based on the array of sequential numbers assigned to a respective parity group. To calculate the redundancy metadata, the processing logic performs an exclusive OR (XOR) operation on host data stored in pages of the block identified by each page number of the array of page numbers assigned to the respective parity group. As previously described, the processing logic iterates through each page number of the array to identify a corresponding page of the block. With each page, host data stored in the page is obtained. The XOR operation is performed on all obtained host data.

At operation 440, the processing logic stores the redundancy metadata in a set of memory cells of the plurality of sets of memory cells identified by a predefined sequential number of the array of sequential numbers assigned to the respective parity group. To store the redundancy metadata, the processing logic identifies a page number appended last to the array of page numbers assigned to the respective parity group. The processing logic performs a programming operation with the redundancy metadata on a page of the block identified by the last page number.

Depending on the embodiment, responsive to a defective page of the block, the processing logic identifies, from the plurality of parity groups, an array of page numbers of a parity group including a page number of the defective page. In particular, the processing logic calculates a parity group identifier based on a page number of a respective page and a wordline number derived from the page number. The processing logic appends, to an array of page numbers assigned to a parity group identified by the parity group identifier, the page number.

For each parity group of a plurality of parity groups, the processing logic determines whether a page number of an array of a respective parity group includes a page number of the defective page. Based on a match, the processing logic identifies a last page number in the array of the respective parity group that includes the page number of the defective page. The processing logic performs a read operations on a page identified by the last page number and reconstructs the defective page using the stored redundancy metadata.

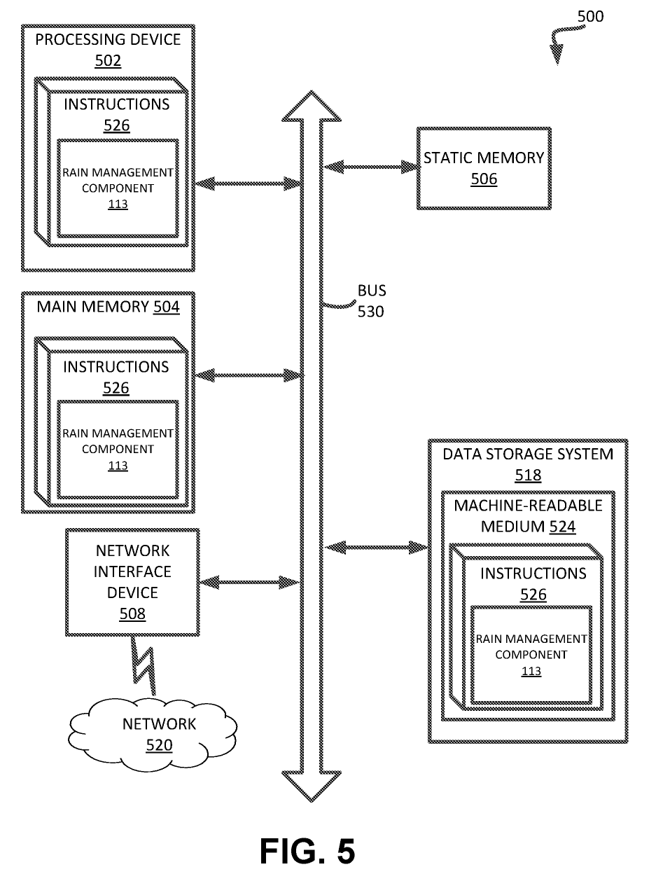

FIG. 5 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub- system (e.g., the memory sub-system 110 of FIG. 1) or can be used to perform the operations of a controller (e.g., to execute an operating system to perform operations corresponding to the RAIN management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term "machine" shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a RAIN management component (e.g., the RAIN management component 113 of FIG. 1). While the machine-readable storage medium 624 is shown in an example embodiment to be a single medium, the term "machine-readable storage medium" should be taken to include a single medium or multiple media that store the one or more sets of instructions. The term "machine-readable storage medium" shall also be taken to include any medium that is capable of storing or encoding a set of instructions for execution by the machine and that cause the machine to perform any one or more of the methodologies of the present disclosure. The term "machine-readable storage medium" shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory ("ROM"), random access memory ("RAM"), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
for each set of memory cells of a plurality of sets of memory cells of a memory device storing host data, calculating, based on a sequential number associated with a respective set of memory cells and a wordline number derived from the sequential number, a parity group identifier;
appending, to an array of sequential numbers assigned to a parity group identified by the parity group identifier, the sequential number;
for each parity group of a plurality of parity groups, calculating, based on the array of sequential numbers assigned to a respective parity group, redundancy metadata; and
storing, in a set of memory cells of the plurality of sets of memory cells identified by a predefined sequential number of the array of sequential numbers assigned to the respective parity group, the redundancy metadata.

2. The method of claim 1, wherein calculating, based on the sequential number associated with the respective set of memory cells and the wordline number derived from the sequential number, the parity group identifier comprises:
determining a block type of the plurality of sets of memory cells;
identifying, based on the block type, a mathematical transformation associated with the block type; and
calculating the parity group identifier using the sequential number associated with the respective set of memory cells and the wordline number derived from the sequential number as input into the mathematical transformation.

3. The method of claim 2, wherein the block type is one of: a single level cell (SLC) block, a multi-level cell (MLC) block, a triple level cell (TLC) block, a quad-level cell (QLC) block, or a penta-level cell (PLC) block.

4. The method of claim 1, wherein calculating, based on the array of sequential numbers assigned to the respective parity group, redundancy metadata comprises:
performing an exclusive disjunction (XOR) operation on host data stored in the plurality of sets of memory cells identified by the array of sequential numbers assigned to the respective parity group.

5. The method of claim 1, wherein storing, in the set of memory cells of the plurality of sets of memory cells identified by the predefined sequential number of the array of sequential numbers assigned to the respective parity group, the redundancy metadata comprises:
identifying a most recently appended sequential number to the array of sequential numbers assigned to the respective parity group, wherein the sequential number appended last corresponds to the last sequential number of the array of sequential numbers; and
storing the redundancy metadata on the set of memory cells of the plurality of sets of memory cells identified by the predefined sequential number.

6. The method of claim 1, further comprising:
responsive to detecting a defective set of memory cells of the plurality of sets of memory cells, identifying, from the plurality of parity groups, an array of sequential numbers of a parity group including a sequential number of the defective set of memory cells;
obtaining, from a predefined sequential number of the array of sequential numbers of the parity group, the redundancy metadata; and
reconstructing, using the redundancy metadata, host data stored in the defective set of memory cells.

7. The method of claim 6, wherein identifying, from the plurality of parity groups, the array of sequential numbers of a parity group including the sequential number of the defective set of memory cells comprises:
for each set of memory cells of the plurality of sets of memory cells, calculating, based on a sequential number of a respective set of memory cells and a wordline number derived from the sequential number, a parity group identifier;
appending, to an array of sequential numbers assigned to a parity group identified by the parity group identifier, the sequential number;
for each parity group of a plurality of parity groups, determining whether a sequential number of an array of sequential numbers assigned to a respective parity group includes the sequential number of the defective set of memory cells; and
responsive to determining that the array of sequential number of the respective parity group includes the sequential number of the defective set of memory cells, returning the array of sequential numbers of the respective parity group.

8. A system comprising:
a plurality of memory devices; and
a processing device, operatively coupled with the plurality of memory devices, to perform operations comprising:
for each set of memory cells of a plurality of sets of memory cells of a memory device storing host data, calculating, based on a sequential number associated with a respective set of memory cells and a wordline number derived from the sequential number, a parity group identifier;
appending, to an array of sequential numbers assigned to a parity group identified by the parity group identifier, the sequential number;
for each parity group of a plurality of parity groups, calculating, based on the array of sequential numbers assigned to a respective parity group, redundancy metadata; and
storing, in a set of memory cells of the plurality of sets of memory cells identified by a predefined sequential number of the array of sequential numbers assigned to the respective parity group, the redundancy metadata.

9. The system of claim 8, wherein calculating, based on the sequential number associated with the respective set of memory cells and the wordline number derived from the sequential number, the parity group identifier comprises:
determining a block type of the plurality of sets of memory cells;
identifying, based on the block type, a mathematical transformation associated with the block type; and
calculating the parity group identifier using the sequential number associated with the respective set of memory cells and the wordline number derived from the sequential number as input into the mathematical transformation.

10. The system of claim 9, wherein the block type is one of: a single level cell (SLC) block, a multi-level cell (MLC) block, a triple level cell (TLC) block, a quad-level cell (QLC) block, or a penta-level cell (PLC) block.

11. The system of claim 8, wherein calculating, based on the array of sequential numbers assigned to the respective parity group, redundancy metadata comprises:
performing an exclusive disjunction (XOR) operation on host data stored in the plurality of sets of memory cells identified by the array of sequential numbers assigned to the respective parity group.

12. The system of claim 8, wherein storing, in the set of memory cells of the plurality of sets of memory cells identified by the predefined sequential number of the array of sequential numbers assigned to the respective parity group, the redundancy metadata comprises:
identifying a most recently appended sequential number to the array of sequential numbers assigned to the respective parity group, wherein the sequential number appended last corresponds to the last sequential number of the array of sequential numbers; and
storing the redundancy metadata on the set of memory cells of the plurality of sets of memory cells identified by the predefined sequential number.

13. The system of claim 8, wherein the processing device is to perform operations further comprising:
responsive to detecting a defective set of memory cells of the plurality of sets of memory cells, identifying, from the plurality of parity groups, an array of sequential numbers of a parity group including a sequential number of the defective set of memory cells;
obtaining, from a predefined sequential number of the array of sequential numbers of the parity group, the redundancy metadata; and
reconstructing, using the redundancy metadata, host data stored in the defective set of memory cells.

14. The system of claim 13, wherein identifying, from the plurality of parity groups, the array of sequential numbers of a parity group including the sequential number of the defective set of memory cells comprises:
for each set of memory cells of the plurality of sets of memory cells, calculating, based on a sequential number of a respective set of memory cells and a wordline number derived from the sequential number, a parity group identifier;
appending, to an array of sequential numbers assigned to a parity group identified by the parity group identifier, the sequential number;
for each parity group of a plurality of parity groups, determining whether a sequential number of an array of sequential numbers assigned to a respective parity group includes the sequential number of the defective set of memory cells; and
responsive to determining that the array of sequential number of the respective parity group includes the sequential number of the defective set of memory cells, returning the array of sequential numbers of the respective parity group.

15. A non-transitory computer-readable storage medium comprising instructions that, when executed by a processing device, cause the processing device to perform operations comprising:
for each set of memory cells of a plurality of sets of memory cells of a memory device storing host data, calculating, based on a sequential number associated with a respective set of memory cells and a wordline number derived from the sequential number, a parity group identifier;
appending, to an array of sequential numbers assigned to a parity group identified by the parity group identifier, the sequential number;
for each parity group of a plurality of parity groups, calculating, based on the array of sequential numbers assigned to a respective parity group, redundancy metadata; and
storing, in a set of memory cells of the plurality of sets of memory cells identified by a predefined sequential number of the array of sequential numbers assigned to the respective parity group, the redundancy metadata.

16. The non-transitory computer-readable storage medium of claim 15, wherein calculating, based on the sequential number associated with the respective set of memory cells and the wordline number derived from the sequential number, the parity group identifier comprises:
determining a block type of the plurality of sets of memory cells;
identifying, based on the block type, a mathematical transformation associated with the block type; and
calculating the parity group identifier using the sequential number associated with the respective set of memory cells and the wordline number derived from the sequential number as input into the mathematical transformation.

17. The non-transitory computer-readable storage medium of claim 16, wherein calculating, based on the array of sequential numbers assigned to the respective parity group, redundancy metadata comprises:
performing an exclusive disjunction (XOR) operation on host data stored in the plurality of sets of memory cells identified by the array of sequential numbers assigned to the respective parity group.

18. The non-transitory computer-readable storage medium of claim 15, wherein storing, in the set of memory cells of the plurality of sets of memory cells identified by the predefined sequential number of the array of sequential numbers assigned to the respective parity group, the redundancy metadata comprises:
identifying a most recently appended sequential number to the array of sequential numbers assigned to the respective parity group, wherein the sequential number appended last corresponds to the last sequential number of the array of sequential numbers; and
storing the redundancy metadata on the set of memory cells of the plurality of sets of memory cells identified by the predefined sequential number.

19. The non-transitory computer-readable storage medium of claim 15, wherein the processing device is to perform operations further comprising:
responsive to detecting a defective set of memory cells of the plurality of sets of memory cells, identifying, from the plurality of parity groups, an array of sequential numbers of a parity group including a sequential number of the defective set of memory cells;
obtaining, from a predefined sequential number of the array of sequential numbers of the parity group, the redundancy metadata; and
reconstructing, using the redundancy metadata, host data stored in the defective set of memory cells.

20. The non-transitory computer-readable storage medium of claim 19, wherein identifying, from the plurality of parity groups, the array of sequential numbers of a parity group including the sequential number of the defective set of memory cells comprises:
for each set of memory cells of the plurality of sets of memory cells, calculating, based on a sequential number of a respective set of memory cells and a wordline number derived from the sequential number, a parity group identifier;
appending, to an array of sequential numbers assigned to a parity group identified by the parity group identifier, the sequential number;
for each parity group of a plurality of parity groups, determining whether a sequential number of an array of sequential numbers assigned to a respective parity group includes the sequential number of the defective set of memory cells; and
responsive to determining that the array of sequential number of the respective parity group includes the sequential number of the defective set of memory cells, returning the array of sequential numbers of the respective parity group.
